(19) United States
(12) Patent Application Publication
(10) Pub. No.: US 2017/0003071 A1
(43) Pub. Date: Jan. 5, 2017

(54) PURIFYING CRYOGENIC FLUIDS

(71) Applicant: CooperSurgical, Inc., Trumbull, CT (US)

(72) Inventors: Patrick N. Gutelius, Wallingford, CT (US); James R. Parys, Wallingford, CT (US)

(21) Appl. No.: 15/195,337

(22) Filed: Jun. 28, 2016

Related U.S. Application Data
(60) Provisional application No. 62/187,936, filed on Jul. 2, 2015.

(51) Int. Cl. F25J 1/00; A01N 1/02; B01D 53/22; F17C 3/00; B01D 46/00

(52) U.S. Cl. CPC F25J 1/0072; F17C 3/00; F25J 1/0015; B01D 46/0028; B01D 46/0036; B01D 53/22; A01N 1/0263; F17C 2205/0149; F17C 2205/0341; F17C 2221/033; F17C 2265/012; F25J 2210/02; F25J 2210/40; F25J 2210/42; F25J 2215/42; F25J 2290/30; F25J 2250/02; F25J 2240/44; F25J 2220/44; F25J 2205/84

(57) ABSTRACT

A cryogenic fluid purification device comprising: a first container defining an interior region; a second container defining an interior region in fluid communication with the interior region of the first container; and a cryogenic fluid in contact with an exterior of the second container.

### CROSS-REFERENCE TO RELATED APPLICATIONS

This application claims priority to U.S. Provisional Patent Application No. 62/187,936, filed on Jul. 2, 2015, the entire contents of which is incorporated herein by reference.

### FIELD

This disclosure relates to devices and methods for purifying cryogenic fluids.

### BACKGROUND

Nitrogen, as an element of great technical importance, can be produced in a cryogenic nitrogen plant. Air inside a distillation column is separated at cryogenic temperatures (about 100K/−173° C.) to produce high purity nitrogen with 1 ppm of impurities. The process is based on the air separation, which was invented by Dr. Carl von Linde in 1895.

The main purpose of a cryogenic nitrogen plant is to provide a customer with high purity gaseous nitrogen (GAN). In addition, liquid nitrogen (LN) is produced simultaneously and is typically 10% of the gas production. LN produced by cryogenic plants is stored in a local tank and used as a strategic reserve.

Liquid nitrogen is a compact and readily transported source of nitrogen gas without pressurization. Further, its ability to maintain temperatures far below the freezing point of water makes it extremely useful in a wide range of applications, primarily as an open-cycle refrigerant.

### SUMMARY

The systems and methods described in this disclosure provide a means for users of cryogenic fluid to overcome the challenge of obtaining purified (ideally sterile) cryogenic fluid. These systems and methods are particularly beneficial to cryogenic preservation facilities such as in vitro fertilization facilities and labs which were often not able to afford to implement filtering techniques to purify commercial grade cryogenic fluid (i.e., liquid nitrogen).

These systems and methods use a cryogenic fluid such as commercial grade liquid nitrogen to generate highly purified liquid nitrogen from the commercial grade liquid nitrogen and/or from nitrogen in the air. The systems and methods promote the condensation of nitrogen while specifically preventing the condensation of oxygen from source air.

The condensation can be achieved in an open system or a closed system. Condensation can be assisted by utilizing the pressure/temperature relationships of fluidic/gaseous systems' characteristics (i.e. drawing a vacuum lowers the boiling temperature).

In one aspect, a cryogenic fluid purification device includes: a first container defining an interior region; a second container defining an interior region in fluid communication with the interior region of the first container; and a cryogenic fluid in contact with an exterior of the second container. Embodiments can include one or more of the following features.

In some embodiments, the second container is sized and configured to be received at least partially in the interior region of the first container. In some cases, the device includes a manifold extending from an outlet of the first container to an inlet of the second container. The manifold can include an oxygen rejecting filter. In some cases, the device includes a pump operable to reduce pressure in the interior region of the first container.

In some embodiments, the device includes a filter disposed in a path providing fluid communication between the interior region of the second container and the interior region of the first container.

In some embodiments, the first container comprises a spout configured to engage a port of the second container. In some cases, the device includes a third container defining an interior region, wherein the second container is sized and configured to be received at least partially in the interior region of the third container.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic view of a cryogenic fluid purification device.

FIGS. 2A and 2B show a pressure-temperature phase diagram for nitrogen.

FIG. 3 is a schematic view of a cryogenic fluid purification device.

FIG. 4 is a schematic view of a cryogenic fluid purification device.

FIG. 5 is a schematic view of a cryogenic fluid purification device.

Like reference symbols in the various drawings indicate like elements.

### DETAILED DESCRIPTION

The systems and methods described in this disclosure provide a means for users of cryogenic fluid to overcome the challenge of obtaining purified (ideally sterile) cryogenic fluid. These systems and methods are particularly beneficial to cryogenic preservation facilities such as in vitro fertilization facilities and labs which were often not able to afford to implement filtering techniques to purify commercial grade cryogenic fluid (i.e., liquid nitrogen).

These systems and methods use a cryogenic fluid such as commercial grade liquid nitrogen to generate a highly purified cryogenic fluid (e.g., highly purified liquid nitrogen) from the commercial grade cryogenic fluid and/or from gases in the air. In some embodiments, the systems and methods promote the condensation of nitrogen while specifically preventing the condensation of oxygen from source air.

The condensation can be achieved in an open system or a closed system. Condensation can be assisted by utilizing the pressure/temperature relationships of fluidic/gaseous systems' characteristics (i.e. drawing a vacuum lowers the boiling temperature).

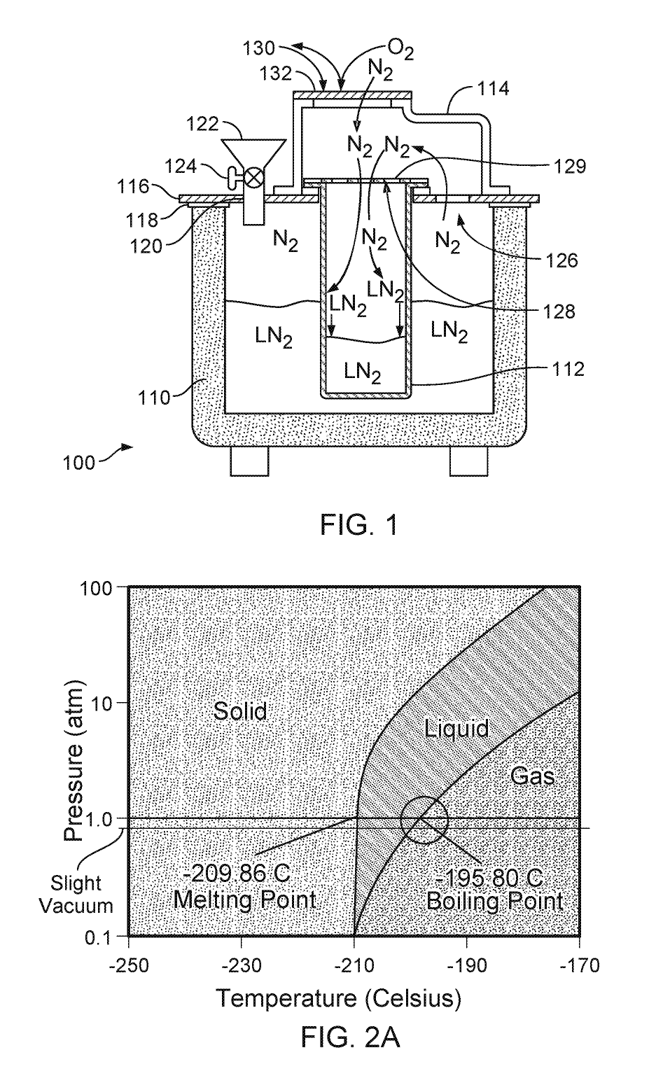

FIG. 1 shows a device 100 that provides for purification of commercial grade liquid nitrogen as well as for production of liquid nitrogen from air around the device. The device 100 includes a first container (e.g., outer container 110), a second (e.g., inner container 112), and a manifold 114. The manifold 114 provides a fluid flow path connecting the outer container 110 and the inner container 112 such that gas formed by evaporation of cryogenic fluid in the outer container 110 can flow into the inner container 112.

The outer container 110 is an insulated container which limits the transfer of heat from the environment into the outer container 110. In the device 100, the outer container 110 includes polystyrene foam as an insulating material. In some embodiments, the outer container 110 includes other materials characterized by low heat conductivity such as other foams or “vacuum-based-insulation” in which two layers are separated by a gap which is partially evacuated of air, creating a near-vacuum instead or in addition to the polystyrene foam. The insulation provided by the outer container helps maintain the contents of the outer container (e.g., the commercial grade liquid nitrogen) at low temperature for a longer period than would be possible without the insulating effect of the outer container 110. The outer container 110 is generally cylindrical in shape. In some embodiments, outer containers are formed in other shapes.

A lid 116 extends across an open end of the outer container 110 with a seal 118 limiting (e.g., preventing) fluid flow between the outer container 110 and the lid 116. A first port (e.g., filling port 120) extends through the lid 116 and can be used to introduce cryogenic fluid into the outer container 110. The device 100 includes a funnel 122 with a valve 124 that facilitates adding cryogenic fluid to the outer container 110. Some devices include other mechanisms for adding cryogenic fluid to the outer container. For example, a reservoir (e.g., a storage tank) of commercial grade liquid nitrogen can be connected to the device by permanently installed piping. However, it is anticipated that manually filled devices such as the device 100 will be appropriate for small-scale facilities with limited needs for highly purified cryogenic fluid.

As discussed above, the manifold 114 provides a fluid flow path connecting the outer container 110 and the inner container 112. The manifold 114 is attached to the lid 116 with an open side of the manifold 114 extending across a second port (e.g., evaporation port 126) and a third port (e.g., condensation port 128). The inner container 112 is inserted through the third port 128 into the chamber defined by the outer container 110 and the lid 116.

The inner container 112 has a flange which rests on a gasket extending around the third port 128. The gasket limits (e.g., prevents) the flow of liquid out of the outer container 110 through gaps between the inner container 112 and the lid 116. In some embodiments, other seals provide this function. For example, some lids include an elastic member extending around an inner perimeter of the third port. In addition, some devices include closures which may be movable between closed positions limiting fluid flow through the ports 120, 126, 128 and open positions allowing substantially free fluid flow through the ports 120, 126, 128. The closures can be, for example, secondary lids or corks.

In contrast to the outer container 110, the inner container 112 has thin walls made of materials characterized by high thermal conductivity which facilitate heat transfer through the walls. In the device 100, the walls of the inner container are made of 1 mm thick aluminum. In some devices, the walls of the inner container are made of other materials characterized by high thermal conductivity, such as steel, copper, glass, or high density plastic. The term “walls” refers to the boundary structures (e.g. side-walls, bottom walls, and top walls). The inner container 112 is generally cylindrical in shape. In some embodiments, inner containers are formed in other shapes.

The lid 116 also includes a lock engageable to hold the inner container 112 in place relative to the lid and a lock engageable to hold the lid 116 in place relative to the outer container 110. This limits upward movement of the inner container 112/lid 116 due to buoyancy forces when the level of liquid in the space between the inner container 112 and the outer container 110 is higher than the level of liquid within the inner container 112.

A first filter 129 extends across the condensation port 128. The first filter 129 can limit (e.g., prevent) unwanted materials such as particulate matter, bacteria, etc. from entering the inner container 112 through the condensation port 128. The first filter 129 can be, for example, a mechanical filter or a membrane filter. In some embodiments, the first filter 129 comprises a High Efficiency Particulate Air (HEPA) filter. Additionally or alternatively, some filters 129 comprise a porous filter (e.g., a porous filer is characterized by a pore size smaller or equal to 0.22 micrometer), porous paper, a hydrophobic filter (e.g., a Polytetrafluoroethylene (PTFE) or Gore-Tex filter), an absorbing filter (e.g., a filter configured to absorb dust and/or water vapor) comprising an absorbing material, such as an activated carbon, or paper, or any other absorbing material appropriate for the case. In some embodiments, the filter 129 comprises a combination of several sub-filters.

The manifold 114 also defines an atmospheric inlet port 130 that allows gases from the environment surrounding the device 100 to enter the manifold 114. The atmospheric inlet port 130 is an optional feature that is omitted from some devices.

The atmospheric inlet port 130 is optionally covered by a second filter 132. The second filter 132 can be, for example, a mechanical filter or a membrane filter as described above with respect to the first filter. The second filter 132 can limit (e.g., prevent) unwanted materials such as particulate matter, bacteria, etc. from entering the manifold through the atmospheric inlet port 130. The device 100 includes an oxygen rejecting filter such that the device 100 can be used to generate liquid nitrogen from the atmosphere in addition to purifying commercial grade liquid nitrogen. By excluding oxygen to produce liquid nitrogen rather than liquid air which includes both oxygen and nitrogen, the device 100 provides a purified cryogenic fluid that avoids the potential issues of flammability/explosiveness that are associated with oxygen rich gases.

Alternatively, the atmospheric inlet port 130 is optionally covered by a second filter 132. The second filter 132 can be, for example, a filter resistive to all gas passage (e.g. inhibits free flow) such that atmospheric gas is not freely entering the manifold space nor is evaporated nitrogen (e.g. from container 110 or 112) freely exiting the manifold to atmosphere. This resistive filter may filter particulate. This filter may be designed so as to release if any undue pressure builds up (e.g. as a safety relief). Alternatively or additionally, the manifold can include pressure relief valve.

The device 100 produces purified cryogenic fluids by passively cooling gases inside the inner container 112. The term “passive cooling” refers to bringing a first object into thermal contact with a second object, which is colder than the first object, thereby facilitating passive heat transfer from the first object to the second object.

In operation, a user assembles the device 100. After assembly, the user at least partially fills the outer container 110 with a cryogenic fluid to be purified (e.g., commercial grade liquid nitrogen). Initially, the inner container 112 will be filled with gas (e.g., filtered air or filtered nitrogen gas) and the fluid between the inner container 112 and the outer container 110 will exert a buoyancy force on the inner container. Heat transfer into the liquid nitrogen in the outer container 110 causes formation of nitrogen gas through evaporation. At the same time, the liquid nitrogen between the inner container 112 and the outer container 110 cools the gas in the inner container 112 causing condensation forming, for example, liquid nitrogen. The condensation reduces the volume formerly occupied by the gas phase materials and draws additional gas into the inner container 112 through the first filter 129. Thus, evaporated nitrogen passes through the manifold 114 and the first filter 129 into the inner container 112. As the air surrounding the device 100 is predominantly oxygen and nitrogen gas, the gas drawn through the second filter 132 is mostly nitrogen which then passes through the first filter 129 into the inner container.

The inner container 112 and the chamber between the inner container 112 and the outer container 110 are coupled to the air around the device 100 by the atmospheric inlet port 130 of the manifold 114. This connection keeps the pressure in these regions at approximately atmospheric pressure.

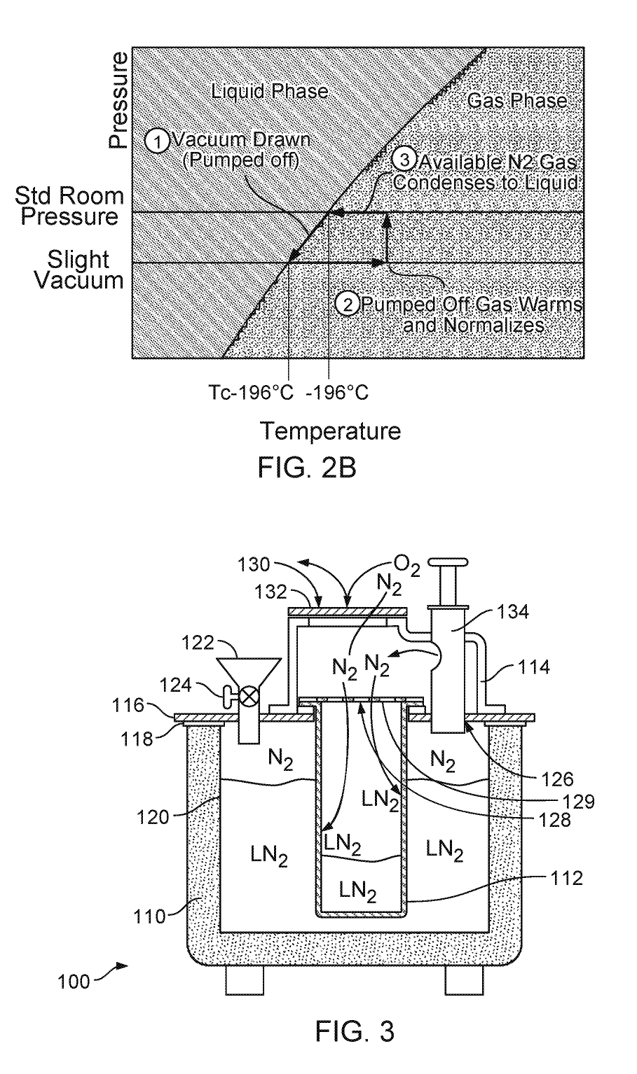

FIGS. 2A and 2B show the state of nitrogen at relative temperatures and pressures. Most in vitro fertilization (IVF) labs use liquid nitrogen as a cryogenic fluid for deep freezing of tissues. The liquid nitrogen is used at standard atmospheric pressure (1 Atm), which means it will boil when its temperature reaches 196° C. FIG. 2B shows the region near the boiling point of liquid nitrogen at standard pressure at larger scale than FIG. 2A. Path 1 shows that if a slight vacuum is drawn on the liquid nitrogen (i.e., container pressure is slightly under 1 Atm.), the boiling temperature of the liquid nitrogen drops. If the gas pulled off during the vacuum drawing process is released to 1 Atm., as shown in path 2, is allowed to cool, it will return to a liquid state, as shown in path .3

FIG. 3 shows an open system device 100 that is generally similar to the device 100 shown in FIG. 1 with the addition of a pump 134 operable to induce a vacuum to the chamber between the outer container 110 and the inner container 112. This pressure reduction reduces the temperature of the liquid nitrogen in the chamber between the outer container 110 and the inner container 112. This reduction in temperature increases the temperature differential that drives the purification and production of liquid nitrogen.

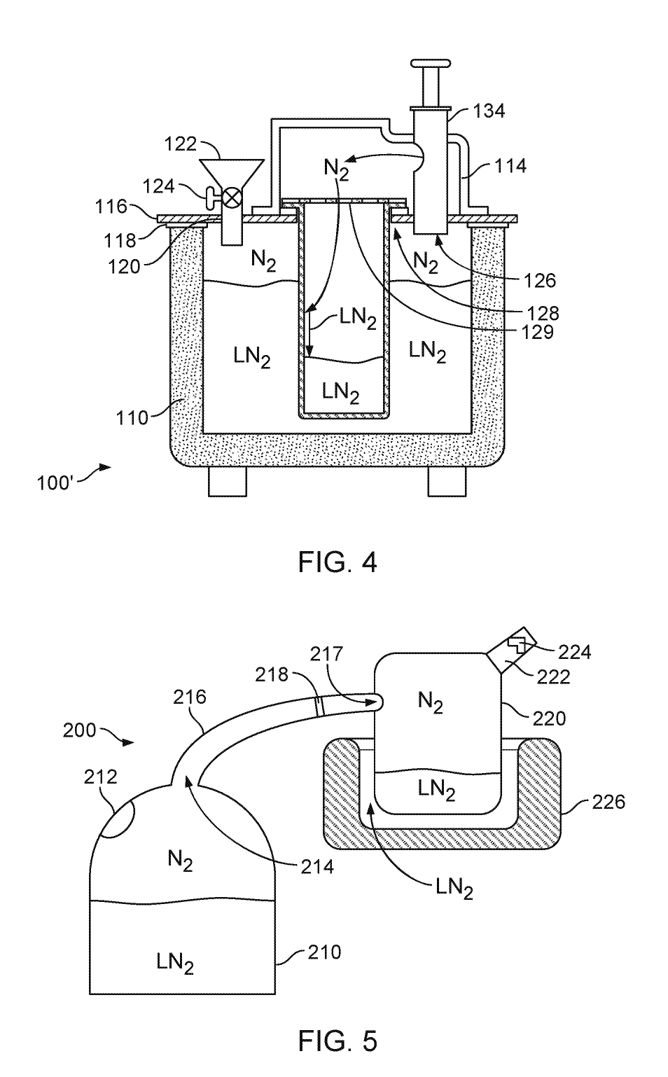

FIG. 4 shows a closed system device 100′. The closed system device 100′ is substantially similar to the open system device 100 but does not include an atmospheric inlet port so the interior of the device 100′ is not exposed to ambient gases during use. The closed system device is operable to purify cryogenic fluids such as liquid nitrogen but does not generate cryogenic fluids from the atmosphere.

The first and second containers are not necessarily outer and inner containers. FIG. 5 illustrates a system 200 in which a first container 210 has a filling port 212 and an evaporation port 214. A spout 216 extends from the evaporation port 214 to a condensation port 217. Optionally, the spout 216 includes a filter 218. The condensation port 217 is configured to engage with a port in the side of a second container 220. The second container 220 also has a spout 222 with a check valve 224. The spout 222/valve 224 combination can be used both as a pressure relief mechanism and as a discharge mechanism for pouring out purified cryogenic fluid from the second container 220. A third container 226 is sized to receive the second container 220 and hold it immersed in cryogenic fluid. The first and second containers 210, 220 are thin-walled containers conducive to heat transfer while the third container 226 is insulated to be resistant to heat transfer. In some embodiments of the system 200, the third container 226 includes a lid to limit the escape of gas phase nitrogen out of the third container.

A number of embodiments of the invention have been described. Nevertheless, it will be understood that various modifications may be made without departing from the spirit and scope of the invention. Accordingly, other embodiments are within the scope of the following claims.

What is claimed is:

1. A cryogenic fluid purification device comprising:
a first container defining an interior region;
a second container defining an interior region in fluid communication with the interior region of the first container; and
a cryogenic fluid in contact with an exterior of the second container.

2. The device of claim 1, wherein the second container is sized and configured to be received at least partially in the interior region of the first container.

3. The device of claim 2, comprising a manifold extending from an outlet of the first container to an inlet of the second container.

4. The device of claim 3, the manifold comprising an oxygen rejecting filter.

5. The device of claim 3, the manifold comprising pressure relief

6. The device of claim 2, comprising a pump operable to reduce pressure in the interior region of the first container.

7. The device of claim 1, comprising a filter disposed in a path providing fluid communication between the interior region of the second container and the interior region of the first container.

8. The device of claim 1, wherein the first container comprises a spout configured to engage a port of the second container.

9. The device of claim 8, comprising a third container defining an interior region, wherein the second container is sized and configured to be received at least partially in the interior region of the third container.
